(19) United States
(12) Patent Application Publication
(10) Pub. No.: US 2026/0249184 A1
(43) Pub. Date: Aug. 27, 2026

(54) INFORMATION PROCESSING SYSTEM AND INFORMATION PROCESSING METHOD

(71) Applicant: MIXI, INC., Tokyo (JP)

(72) Inventors: Takeshi HOSHINO, Tokyo (JP); Endi CHONG, Tokyo (JP); Tomoki UMEZAWA, Tokyo (JP); Takashi SUGIYAMA, Tokyo (JP); Hiroshi NIKAIDO, Tokyo (JP); Daigo YATO, Tokyo (JP)

(73) Assignee: MIXI, INC., Tokyo (JP)

(21) Appl. No.: 18/877,478

(22) PCT Filed: Jul. 3, 2023
(86) PCT No.: PCT/JP2023/024690

§ 371 Date: Dec. 20, 2024

(30) Foreign Application Priority Data
Jul. 4, 2022 (JP) 2022-107746

(51) Int. Cl. A63F 13/55; A63F 13/525; A63F 13/5375; G06T 19/20

(52) U.S. Cl. CPC A63F 13/55; A63F 13/525; A63F 13/5375; G06T 19/20; G06T 2219/2004; G06T 2219/2012

(57) ABSTRACT

An information processing system includes a server and first and second user terminals that communicate with the server. The server includes a first processor which controls movement of a first object in a virtual space based on operation information received from the first user terminal. The first processor sets the first object for a first or second mode if the first object satisfies a predetermined condition. The second user terminal includes a second processor displaying an image where a trajectory object displaying a movement trajectory of part of the first object is displayed in the virtual space together with the first object when the first mode is set for the first object, The second processor does not perform the display processing when the second mode is set for the first object. The information processing system and an information processing method capable of reducing a processing load on a server side.

One of the objects of the present invention is to provide an information processing system and an information processing method capable of reducing a processing load on a server side.

The information processing system comprises a server, a first user terminal and a second user terminal that communicate with the server. The server includes a first processor. The first processor controls a movement of a first object arranged in a virtual space based on operation information received from the first user terminal. The first processor sets the first object for a first mode or a second mode according to whether the first object satisfies a predetermined condition. The second user terminal includes a second processor. The second processor performs a display processing to display on a display an image where a trajectory object for displaying a movement trajectory of a predetermined part of the first object is displayed in the virtual space together with the first object when the first mode is set for the first object. And the second processor does not perform the display processing when the second mode is set for the first object.

### TECHNICAL FIELD

The present invention relates to an information processing system and an information processing method.

### BACKGROUND ART

With the recent advances in network technology, online games (network games) where multiple players participate and the game progresses become increasingly popular. A system for playing online games consists of a server device managed by an operator of the online game, and each player's client device that can connect to the server device via a network such as the Internet (see, for example, Patent Literature 1).

### CITATION LIST

### Patent Literature

[Patent Literature 1] JP-A-2002-219283

### SUMMARY OF INVENTION

### Technical Problem

However, while online games can provide expressive game content even to client devices with low processing power by processing game data including graphic data on a server device, there is a problem in that a processing load on the server increases as a number of simultaneously connected clients increases.

One of the purposes of the present invention is to provide an information processing system and an information processing method capable of reducing a processing load on a server side.

### Solution to Problem

The information processing system according to the present invention is an information processing system comprising a server, a first user terminal and a second user terminal that communicate with the server, wherein the server includes a first processor, the first processor controls a movement of a first object arranged in a virtual space based on operation information received from the first user terminal, the first processor sets the first object for a first mode or a second mode according to whether the first object satisfies a predetermined condition, the second user terminal includes a second processor, the second processor performs a display processing to display on a display an image where a trajectory object for displaying a movement trajectory of a predetermined part of the first object is displayed in the virtual space together with the first object when the first mode is set for the first object, and the second processor does not perform the display processing when the second mode is set for the first object.

According to one aspect of the present invention, it is possible to reduce a processing load on a server side.

### BRIEF DESCRIPTION OF DRAWINGS

FIG. 1 is a diagram showing a configuration of a game system in this embodiment.

FIG. 2 is a block diagram showing a hardware configuration of a server in this embodiment.

FIG. 3 is a block diagram showing a hardware configuration of a user terminal in this embodiment.

FIG. 4 is a block diagram showing an example of a functional configuration of a server in this embodiment.

FIG. 5 is an example of a game screen displayed on a display unit of a user terminal.

FIG. 6 is an example of a game screen displayed on the display unit of a user terminal.

FIG. 7 is an example of a game screen displayed on the display unit of a user terminal.

FIG. 8 is an example of a game screen displayed on the display unit of a user terminal.

FIG. 9 is a flowchart showing an example of a display control processing performed by a server.

FIG. 10 is an example of a part of a character where a trajectory object is arranged.

FIG. 11 is a diagram explaining display control of a trajectory object according to a distance between the trajectory object and a virtual camera.

FIG. 12 is a diagram explaining control of a number of parts of a character where a trajectory object is displayed.

FIG. 13 is a flowchart showing an example of a mode setting processing performed by a server.

FIG. 14 is a flowchart showing an example of a display control processing performed by a user terminal.

### DESCRIPTION OF EMBODIMENTS

### First Embodiment

There are games where a user plays by moving a character around a field in a 3D (three-dimensional) virtual space. In some of these games, NPCs (non-player characters) are tasked with missions. For example, missions include obtaining a specific item in the field, destroying a specific facility in the field, etc., and if successful, the game can be advanced to an advantage.

However, in games where a user plays by moving a character (game medium) around a field in a virtual space, there is a problem that it may be difficult to grasp a location of a game medium that corresponds to users with different attributes and that satisfies a predetermined condition and that can be moved around.

The purpose of a first embodiment of the present invention is to provide an information processing device, an information processing method, and an information processing program can easily grasp a location of a game medium that corresponds to users with different attributes and that satisfies a predetermined condition and that can be moved around.

The first embodiment of the present invention will be described below with reference to the accompanying drawings. In each drawing, parts with the same reference numerals have the same or similar configurations.

### Configuration of Game System 1

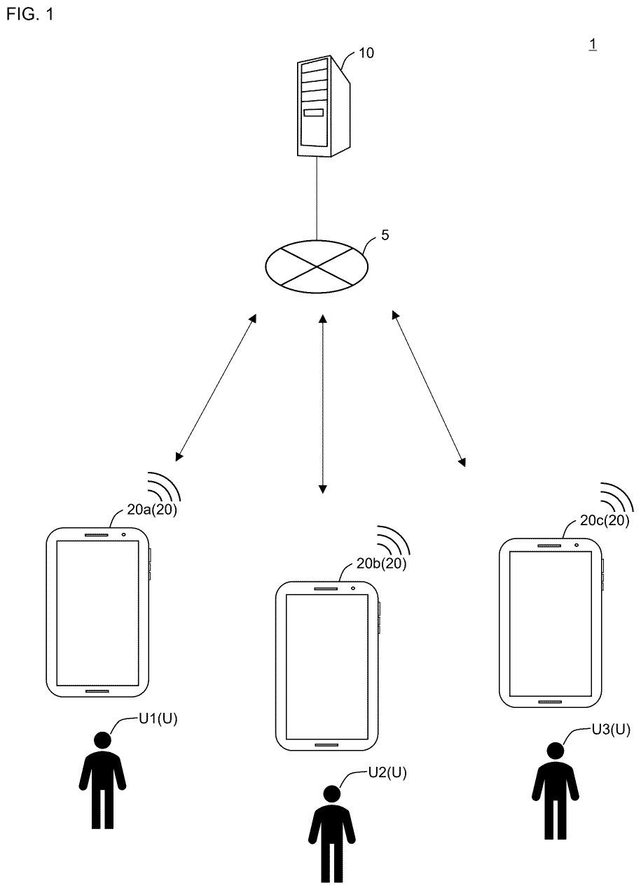

FIG. 1 shows a configuration of a game system 1 in this embodiment. The game system 1 shown in FIG. 1 includes a server 10 (game server) and a plurality of user terminals 20 (user terminal 20a, user terminal 20b, user terminal 20c). The server 10 and the user terminals 20 are connected to each other so that they can communicate with each other via a communication line 5 such as the Internet, an intranet, a wireless LAN, or mobile communications. It is noted that the server 10 functions as the “information processing device” in this embodiment.

In this embodiment, users who use the user terminal 20a, the user terminal 20b, and the user terminal 20c are referred to as a user U1, a user U2, and a user U3, respectively. When there is no need to distinguish between the user U1, the user U2, and the user U3, the user U1, the user U2, and the user U3 will each be referred to as a user U.

Furthermore, when there is no need to distinguish between the user terminal 20a, the user terminal 20b, and the user terminal 20c, the user terminal 20a, the user terminal 20b, and the user terminal 20c will each be referred to as the user terminal 20.

It is noted that a number of the user terminals 20 included in the game system 1 is not limited to three, and it is sufficient that the game system 1 includes at least one user terminal 20.

The user terminal 20 is an information processing terminal such as a smartphone or tablet terminal, and provides a game to the user U. The user U can log in to the game and play the game by operating the user terminal 20. The user terminal 20 may be any type of terminal, such as a mobile phone, a personal computer (PC), a notebook PC, a personal digital assistant (PDA), or a home gaming device. The user terminal 20 may notify the server 10 of its own position detected using a GPS (Global Positioning System), etc.

The server 10 is a device that performs some of the functions of the user terminal 20 in providing the game, such as managing various information related to the user U and performing some of the game processing. The server 10 may be configured by one or more information processing devices, or may be configured using a virtual server (such as a cloud server).

### Game Overview

Next, an overview of the game provided by the game system 1 will be described. The game provided by the game system 1 is a game where an infiltration side user U (specifically, a character corresponding to the infiltration side user U, which corresponds to the “first game medium” in this embodiment) aims to invade a field created in advance by a defense side user U in a virtual space (game space) and steal a specified item secretly and escape. The infiltration side user U can organize an infiltration side team from a plurality of users U. The upper limit (maximum number of players) of the number of users U who organize the infiltration side team is not particularly limited and may be set to any number, but it is preferable to set it to a maximum of about five people, for example. Traps (gimmicks) are set in the field by the defense side user U, and the infiltration side user U conquers the field while avoiding the traps. The defense side user U (specifically, a character corresponding to the defense side user U, which corresponds to the “second game medium” in this embodiment) and a patrol soldier character who is an NPC (non-player character) use a means of searching for enemies such as a light to search for the infiltration side user U to prevent the specified item from being stolen, and prevent the infiltration side user U from escaping. When the infiltration side user U succeeds in stealing the specified item and escaping, the infiltration side user U wins, and when the defense side user U succeeds in preventing the infiltration side user U from escaping, the defense side user U wins.

In the game, there are alert levels 1 to 5. The color of certain areas on the field changes according to the alert level. The behavior of various traps on the field and the conditions of the game also change according to the alert level.

For example, at alert level 1 (non-alert state), the brightness of the virtual space is set to “dark”, the trap function is deactivated, and the defense side NPCs are deactivated (asleep). At alert level 2 (enemy search state), the brightness of the virtual space is set to “dark”, the trap function is deactivated, and the defense side NPCs begin searching and attacking the infiltration side user U. At alert level 3 (alert state), the brightness of the virtual space is set to “slightly bright”, the trap function starts loosely, and the defense side NPCs expand the enemy search range of the infiltration side user U. At alert level 4 (attack state), the brightness of the virtual space is set to “bright”, the speed of the trap's movement increases, and the defense side NPCs increase their attack power. At alert level 5 (emergency state), the brightness of the virtual space is set to “bright”, the attack power and movement speed of the trap increase, and the defense side NPCs expand the enemy search range of the infiltration side user U and increase their attack power. It is noted that, at alert level 5 (emergency state), the display color of certain areas within the field changes to red.

The alert level is increased by satisfying the following conditions. That is, when the defense side user U and NPCs illuminate the infiltration side user U with a means of searching for enemies such as a light for a certain amount of time, the alert level is increased by one level. When the defense side user U and NPCs inflict damage on the infiltration side user U using a direct attack means such as an attack item, the alert level is increased by one level. When the defense side user U discover the NPC that was attacked and killed by the infiltration side user U using the light, etc., the alert level is increased by one level. When the infiltration side user U steals (collects) the specified item, the alert level is forcibly increased to alert level 5. When a predetermined amount of time (for example, 20 minutes) has elapsed since the start of game play, the alert level is forcibly increased to alert level 5. When the alert level changes, a message explaining the change is displayed, and an alarm sound corresponding to the change is output.

When the alert level is increased to alert level 5, a time limit is imposed on the infiltration side user U to escape, and restrictions are imposed on the locations where the infiltration side user U can escape. When the infiltration side user U succeeds in escaping, when the infiltration side user U dies, or when the time limit on the infiltration side user U to escape expires, the game ends and the game result is displayed.

The game of this embodiment is a multiplay game where a plurality of users U can operate their own user terminals 20 to play together. That is, the user U can of course play alone (solo play) as the infiltration side or defense side user U, but can also play simultaneously in what is known as multiplay (also called cooperative play) by organizing the infiltration side team with other users U. In multiplay, each user U operates a character assigned to them, from among a plurality of characters that organize the infiltration side team.

In this multiplay game, for example, a collaborative relationship is formed between a user U (hereinafter referred to as the host user) who hosts the multiplay game and recruits friends, and a user U (hereinafter referred to as the guest user) who respond to the recruitment and participate in the multiplay game, and the progress of the game is synchronized between the users U (the host user and the guest user) participating in the multiplay game. It is noted that the user U (the host user) can also directly invite other users U (candidate guest users) to play in the multiplay game by sending an invitation message to the other users U via a messaging app.

Multiplay is conducted through the communication function of the user terminal 20 of each user U. Specifically, the guest user makes a matching request with the host user who is hosting a multiplay and recruiting friends, and confirms one or more host users displayed in response to the request. The guest user then applies to participate in the multiplay recruited by the desired host user, and when the host user approves the application, a communication path for multiplay is established between the guest user and the host user. It is noted that the qualifications for applying for multiplay are not particularly limited and can be set arbitrarily. For example, an application may be made to the host user who is within a predetermined distance from the guest user making the application, or an application may be made by a friend (guest user) who is in a friendship relationship with a certain user U and was mutually approved by the users U.

After that, various data required for multiplay is sent and received according to a known communication method. The data at this time may be sent via a client-server method via the server 10, or a P2P (peer-to-peer) method that does not involve the server 10. Multiplay formats are classified into fully synchronous and asynchronous types, but either format may be adopted.

### Hardware Configuration of Server 10

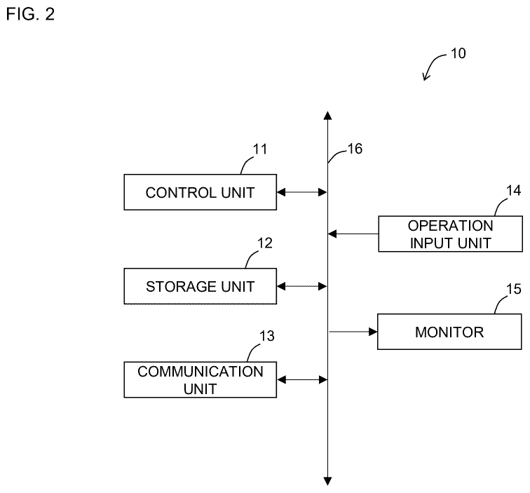

FIG. 2 is a block diagram showing the hardware configuration of the server 10 in this embodiment. As shown in FIG. 2, the server 10 is configured with a control unit 11, a storage unit 12, a communication unit 13, an operation input unit 14, and a monitor 15.

The control unit 11 is, for example, a CPU (Central Processing Unit), a microprocessor, or a DSP (Digital Signal Processor), and controls an overall operation of the server 10.

A part of the storage unit 12 is composed of, for example, RAM (Random Access Memory) or DRAM (Dynamic Random Access Memory), and is used as a work area when the control unit 11 performs a processing based on various programs.

In addition, a part of the storage unit 12 is, for example, a non-volatile memory such as a ROM (Read Only Memory) or an HDD (Hard Disk Drive), and stores various data and programs used in the processing of the control unit 11. The storage unit 12 can hold a database including one or more tables for recording various information and processing results.

The programs stored in the storage unit 12 include, for example, an OS (Operating System) for realizing the basic functions of the server 10, drivers for controlling various hardware, programs for realizing various functions, etc., and include a program that functions as the “information processing program” in this embodiment.

The communication unit 13 is, for example, a NIC (Network Interface Controller) and has a function of connecting to the communication line 5. In addition, instead of or together with the NIC, the communication unit 13 may have a function of connecting to a wireless LAN (Local Area Network), a function of connecting to a wireless WAN (Wide Area Network), a function of enabling short-range wireless communication such as Bluetooth (registered trademark), and infrared communication, etc. The server 10 is connected to the user terminal 20 etc. via the communication line 5, and can transmit and receive various data to and from the user terminal 20, etc.

The operation input unit 14 is composed of a keyboard, a mouse, etc., and accepts input of various operations by a user who uses the server 10. The monitor 15 is, for example, a liquid crystal display device, etc., and displays various images.

The control unit 11, the storage unit 12, the communication unit 13, the operation input unit 14, and the monitor 15 are electrically connected to each other via a system bus 16. Therefore, the control unit 11 can access the storage unit 12, display images on the monitor 15, grasp the operation state of the user on the operation input unit 14, and access various communication networks and the user terminal 20 via the communication unit 13.

### Hardware Configuration of User Terminal 20

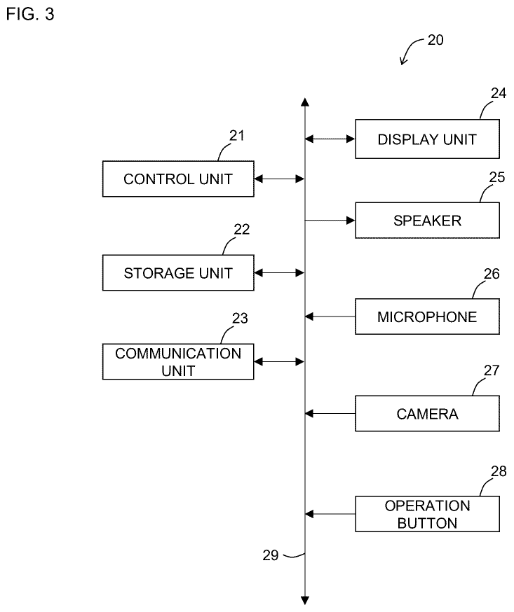

FIG. 3 is a block diagram showing the hardware configuration of the user terminal 20 in this embodiment. As shown in FIG. 3, the user terminal 20 is configured with a control unit 21, a storage unit 22, a communication unit 23, a display unit 24, a speaker 25, a microphone 26, a camera 27, and an operation button 28.

The control unit 21 is, for example, a CPU (Central Processing Unit), a microprocessor, or a DSP (Digital Signal Processor), and controls an overall operation of the user terminal 20.

A part of the storage unit 22 is composed of, for example, RAM (Random Access Memory) or DRAM (Dynamic Random Access Memory), and is used as a work area when the control unit 21 performs a processing based on various programs.

In addition, a part of the storage unit 22 is, for example, a non-volatile memory such as a ROM (Read Only Memory) or an HDD (Hard Disk Drive), and stores various data and programs used in the processing of the control unit 21. The storage unit 22 can hold a database including one or more tables for recording various information and processing results.

The programs stored in the storage unit 22 include, for example, an OS (Operating System) for realizing the basic functions of the user terminal 20, drivers for controlling various hardware, programs for realizing various functions, etc.

The communication unit 23 is, for example, a NIC (Network Interface Controller) and has a function of connecting to the communication line 5. In addition, instead of or together with the NIC, the communication unit 23 may have a function of connecting to a wireless LAN (Local Area Network), a function of connecting to a wireless WAN (Wide Area Network), a function of enabling short-range wireless communication such as Bluetooth (registered trademark), and infrared communication, etc. The user terminal 20 is connected to the server 10, other user terminals 20, etc. via the communication line 5, and can transmit and receive various data between the server 10 and other user terminals 20, etc.

The display unit 24 is a touch panel display, etc., and is capable of displaying images, etc. and accepting operations by the user U.

The speaker 25 outputs various sounds under the control of the control unit 21. The microphone 26 inputs various sounds under the control of the control unit 21. The camera 27 captures an image of a subject under the control of the control unit 21.

The operation button 28 is provided, for example, on the side, etc. of the user terminal 20, and includes a power button for starting or stopping the user terminal 20, a button for adjusting the volume of the sound output from the speaker 25, etc.

The control unit 21, the storage unit 22, the communication unit 23, the display unit 24, the speaker 25, the microphone 26, the camera 27, and the operation button 28 are electrically connected to each other via a system bus 29. Therefore, the control unit 21 can access the storage unit 22, display images on the display unit 24, grasp the operation state of the touch panel display (the display unit 24) and operation button 28 by the user U, input sound to the microphone 26, output sound from the speaker 25, control the camera 27, and access various communication networks, the server 10, other user terminals 20, etc. via the communication unit 23.

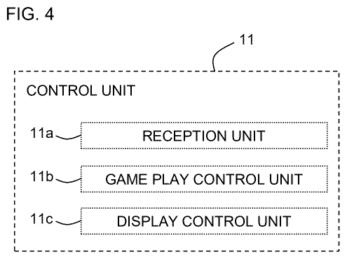

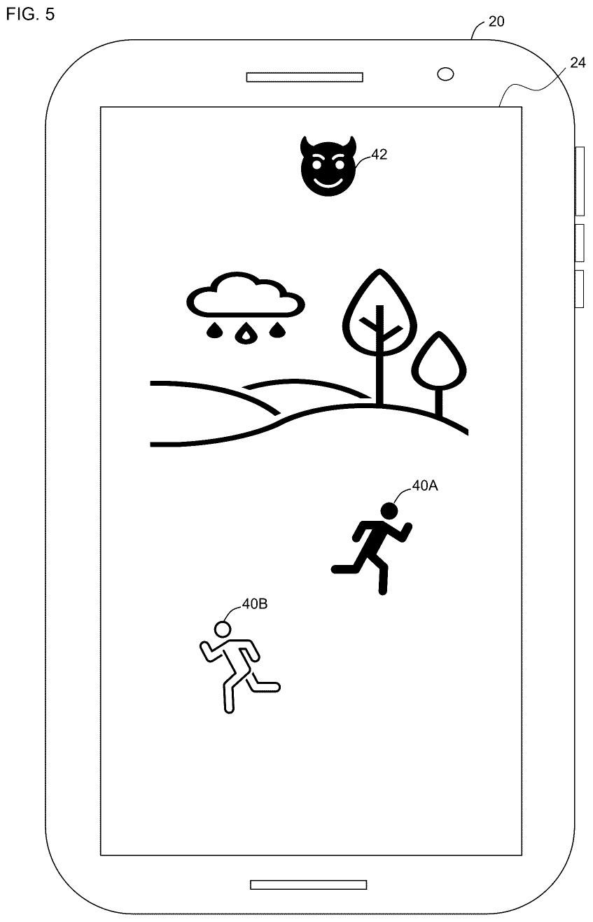

FIG. 4 is a block diagram showing an example functional configuration of the control unit 11 provided in the server 10 in this embodiment. As shown in FIG. 4, the control unit 11 has, as its functional configuration, a reception unit 11a, a game play control unit 11b, and a display control unit 11c. It is noted that the control unit 11 of the server 10 generally has various functions in addition to those described above, but here it is only described functions that are characteristic of the game system 1 in this embodiment, and is not illustrated or described other known functions, etc.

The reception unit 11a accepts a request to play a game from the user U via the user U's operation on the display unit 24 of the user terminal 20.

When the request to play the game is accepted by the reception unit 11a, the game play control unit 11b controls the user U's play of the game.

When a first character (first game medium) corresponding to the infiltration side user U (first attribute) and arranged in the virtual space (game space) satisfies a first predetermined condition while the user U is playing the game, the display control unit 11c controls to identifiably display a first movement history image (for example, a streamlined pink light image or an afterimage image of the first character) showing the movement history of the first character for a predetermined amount of time (for example, several seconds) for the defense side user U (second attribute). Here, the first predetermined condition is, for example, that the first character moves in the virtual space at a predetermined speed or faster. With the above display, the defense side user U can easily grasp a position of the first character that corresponds to the user U of a different attribute (infiltration side), satisfies the first predetermined condition, and is movable in the virtual space. The display control unit 11c may also control to identifiably display the first movement history image by increasing the brightness of the first movement history image as the movement speed of the first character increases.

On the other hand, when a second character (second game medium) that has an attribute different from the infiltration side (first attribute) and is arranged in the virtual space satisfies a second predetermined condition, the display control unit 11c does not control to identifiably display a second movement history image showing the movement history of the second character for the defense side user U. Here, the second predetermined condition is, for example, that the second character moves in the virtual space at a predetermined speed or faster. In this embodiment, the second character is an NPC (non-player character) that searches for the first character using a means of searching for enemies such as a light and prevents the first character from escaping, in order to prevent the first character of the infiltration side from stealing a predetermined item. It is noted that the display control unit 11c controls to identifiably display a light image showing the light of the light used by the second character (NPC) to the defense side user U. It is noted that the first predetermined condition and the second predetermined condition may be the same or different.

When the first character satisfies a first predetermined condition, the display control unit 11c does not control to identifiably display the first movement history image for the infiltration side user U. This allows the infiltration side user U to at least grasp the position of the first character with the same attribute (ally).

When the first character satisfies the first predetermined condition, the display control unit 11c controls to identifiably display a part movement history image (for example, a streamlined pink light image) showing the movement history of the part (for example, head, hand, foot) of the first character in a different display aspect (for example, at least one of color, saturation, brightness, blinking, and size) for each part of the first character for the defense side user U. In this embodiment, the display control unit 11c controls to identifiably display the part movement history image showing the movement history of the part of the first character in a different display aspect (for example, at least one of shape, color, saturation, brightness, blinking, and size) according to the role given to the part of the first character (for example, a weak point, a part that leads to the defense side user U being given a special item when in contact with or attacked by the second character), for the defense side user U.

The display control unit 11c may vary the display aspect (for example, whether or not to display, shape, color, saturation, brightness, blinking, size, etc.) of the part movement history image according to the movement of the part or the shape of the part of the first character. The display control unit 11c may also vary the display aspect (for example, whether or not to display, shape, color, saturation, brightness, blinking, size, etc.) of the part movement history image according to the size of the part of the first character. For example, the display control unit 11c increases the brightness of the part movement history image as the part of the first character becomes larger.

The display control unit 11c may also vary the display aspect (for example, whether or not to display, shape, color, saturation, brightness, blinking, size, etc.) of the part movement history image according to the positional relationship (for example, height from a predetermined position) between a predetermined position (for example, ground position) and the position of the part of the first character in the virtual space. For example, the display control unit 11c increases (or decreases) the brightness of the part movement history image as the height of the part of the first character from a predetermined position (ground position) in the virtual space increases.

The display control unit 11c varies the display aspect (for example, whether or not to display, shape, color, saturation, brightness, blinking, size, etc.) of the first movement history image according to whether the first character is in a predetermined state. Here, the predetermined state is, for example, a state where the first character is transformed into a cat using a transformation item, a state where the first character is crawling forward, or a state where the first character is moving while crouching. In this embodiment, the display control unit 11c does not control to identifiably display the first movement history image when the first character is in the predetermined state, and controls to identifiably display the first movement history image when the first character is not in the predetermined state. It is noted that the display control unit 11c may set the brightness of the first movement history image to less than a predetermined level when the first character is in the predetermined state, and may set the brightness of the first movement history image to the predetermined level or more when the first character is not in the predetermined state.

When a specific object (for example, a car, a motorcycle, a horse, etc., which corresponds to the “third game medium” in this embodiment) arranged in the virtual space moves in association with the first character, specifically, when the first character moves while riding on the specific object, the display control unit 11c controls to identifiably display a third movement history image (for example, a streamlined pink light image) showing the movement history of the specific object in the same display aspect (for example, whether or not to display, shape, color, saturation, brightness, flashing, size, etc.) as the first movement history image, for the defense side user U.

The display control unit 11c controls to identifiably display the first movement history image related to a predetermined movement direction of the first character, and then, when the first character passes again the position where the first movement history image is displayed in a direction different from the predetermined movement direction, while the first movement history image is being displayed, erases the display of the first movement history image.

FIG. 5 is an example of a game screen displayed on the display unit 24 of the user terminal 20 used by the infiltration side user U during game play. As shown in FIG. 5, the game screen displays first characters 40A, 40B corresponding to the infiltration side user U and arranged in the virtual space, and a second character 42 corresponding to the defense side user U and arranged in the virtual space, etc. In the example shown in FIG. 5, the first characters 40A, 40B corresponding to the infiltration side user U are moving left and right in the figure so as not to be searched by the defense side user U (specifically, the second character 42) and NPCs (not shown) using a means of searching for enemies such as a light. The display control unit 11c does not control to identifiably display the first movement history image for the infiltration side user U even when the first characters 40A, 40B satisfy the first predetermined condition.

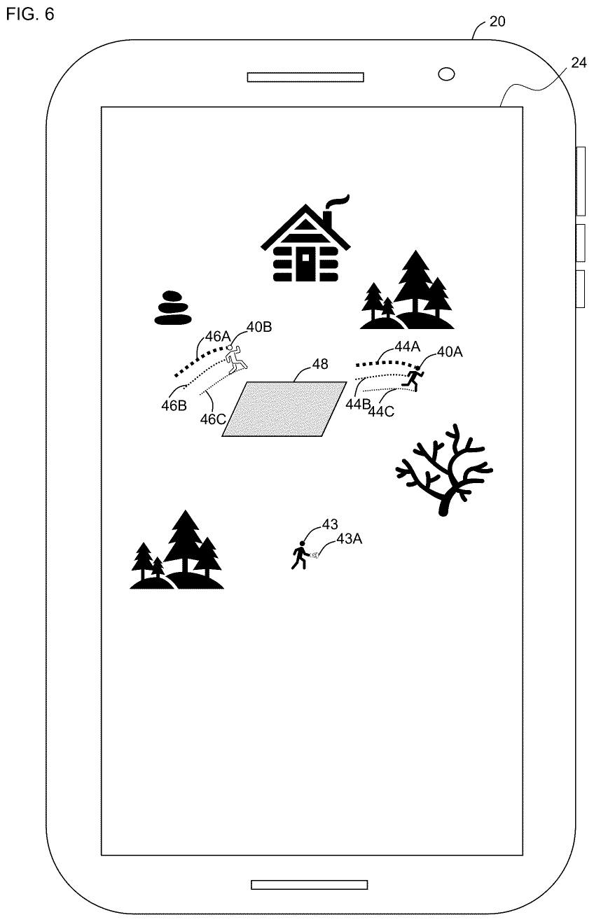

FIG. 6 is an example of a game screen displayed on the display unit 24 of the user terminal 20 used by the defense side user U during game play. As shown in FIG. 6, the game screen displays first characters 40A, 40B corresponding to the infiltration side user U and arranged in the virtual space, the second character 43 (NPC) that has attributes different from the infiltration side and is arranged in the virtual space, and an irradiation area 48 illuminated by the means of searching for enemies such as a light by the second character 42 (see FIG. 5) corresponding to the defense side user U, etc.

In the example shown in FIG. 6, the first characters 40A, 40B corresponding to the infiltration side user U are moving at a predetermined speed or faster so as not to enter the irradiation area 48. In this case, because the first characters 40A, 40B satisfy the first predetermined condition, the display control unit 11c controls to display the first movement history image (specifically, composed of the part movement history images 44A, 44B, 44C, 46A, 46B, 46C) showing the movement history of the first characters 40A, 40B for the defense side user U for a predetermined amount of time (for example, several seconds). Specifically, the display control unit 11c controls to display the part movement history images 44A, 44B, 44C, 46A, 46B, 46C in different display aspects (for example, whether or not to display, shape, color, saturation, brightness, flashing, size, etc.) for each part (for example, head, both hands, both feet) of the first characters 40A, 40B.

The defense side user U can grasp the positions of the first characters 40A, 40B corresponding to the infiltration side user U by looking down from an overhead position in the virtual space. The second character 42 corresponding to the defense side user U changes the irradiation area 48 illuminated by the means of searching for enemies, using the part movement history images 44A, 44B, 44C, 46A, 46B, 46C configuring the first movement history image as landmarks to increase the alert level by one level. The second character 43 (NPC) is searching for the first characters 40A, 40B corresponding to the infiltration side user U using the means of searching for enemies 43A such as a light, while moving so as not to have a specific item stolen. It is noted that the defense side user U can also directly attack the first characters 40A, 40B corresponding to the infiltration side user U.

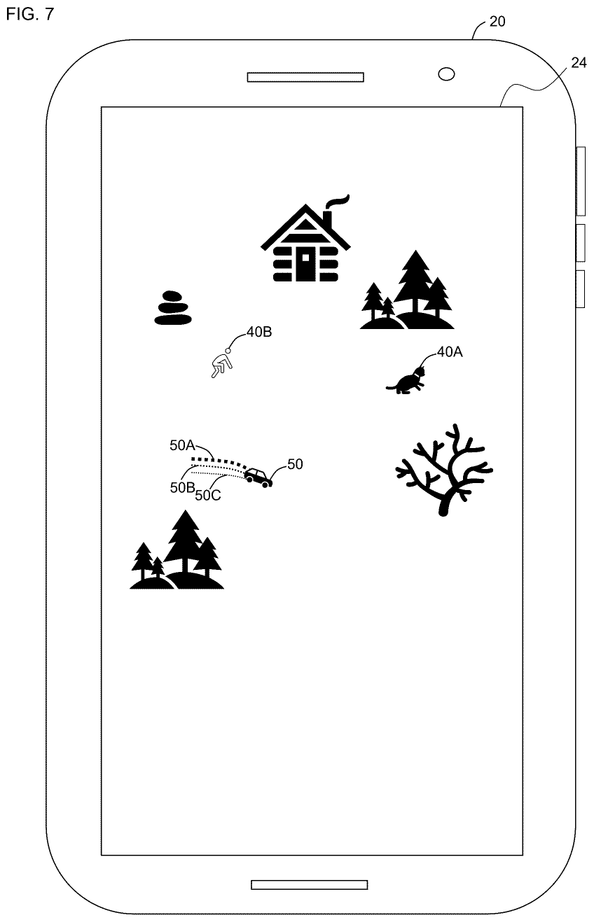

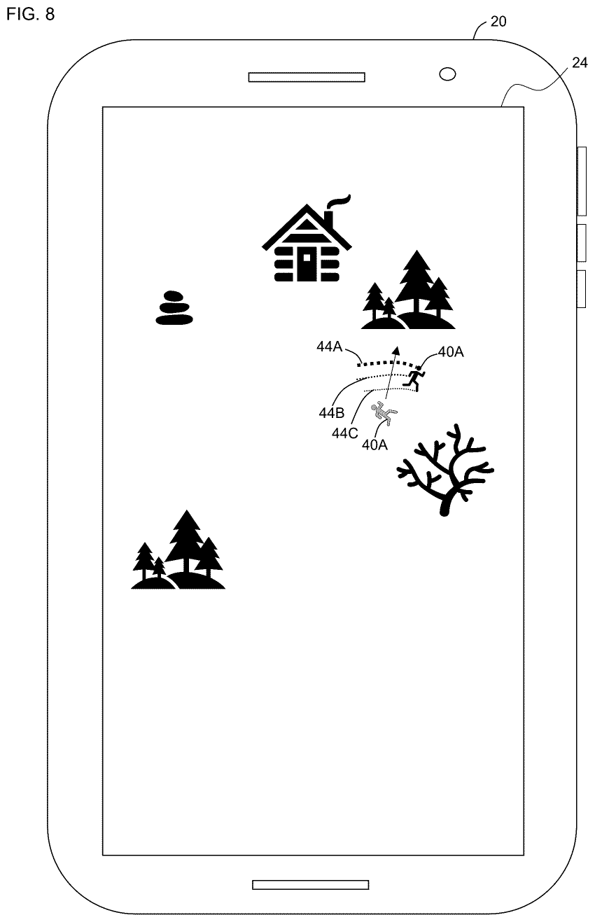

FIG. 7 is an example of a game screen displayed on the display unit 24 of the user terminal 20 used by the defense side user U during game play. As shown in FIG. 7, the game screen displays first characters 40A, 40B that correspond to the infiltration side user U and are arranged in the virtual space, and a specific object 50 (car) that moves in association with the first character (not shown).

In the example shown in FIG. 7, the first character 40A corresponding to the infiltration side user U is transformed into a cat (predetermined state), so the display control unit 11c does not control to identifiably display the first movement history image showing the movement history of the first character 40A. Also, the first character 40B corresponding to the infiltration side user U is crouching and moving (predetermined state), so the display control unit 11c does not control to identifiably display the first movement history image showing the movement history of the first character 40B. Also, the display control unit 11c controls to identifiably display the third movement history image (specifically, composed of the part movement history images 50A, 50B, and 50C) showing the movement history of the specific object 50 in the same display aspect (for example, whether or not to display, shape, color, saturation, brightness, flashing, size, etc.) as the first movement history image the defense side user U, because the specific object 50 arranged in the virtual space is moving in association with the first character (riding the specific object 50). This allows the defense side user U to easily grasp that the specific object 50 associated with the first character is moving.

FIG. 8 is an example of a game screen displayed on the display unit 24 of the user terminal 20 used by the defense side user U during game play. As shown in FIG. 8, the game screen displays the first character 40A, etc. that correspond to the infiltration side user U and are arranged in the virtual space. The display control unit 11c controls to identifiably display the first movement history image (specifically, composed of the part movement history images 44A, 44B, and 44C) related to the predetermined movement direction of the first character 40A (movement direction from left to right in the example of FIG. 8), and then erases the display of the first movement history image when the first character 40A again passes through the position where the first movement history image is displayed in a direction different from the predetermined movement direction (movement direction from bottom to top in the example of FIG. 8) while the first movement history image is displayed, in other words, shortens the display amount of time of the first movement history image. This makes it difficult for the infiltration side user U to grasp the position of the first character 40A. In addition, the display control unit 11c may, after identifiably displaying a first movement history image related to a predetermined movement direction (rightward in the example of FIG. 8) of the first character 40A, erase the display of the first movement history image when the first character 40A moves again in the opposite direction to the predetermined movement direction (movement direction from right to left in the example of FIG. 8) so as to trace the movement history corresponding to the first movement history image while the first movement history image is displayed.

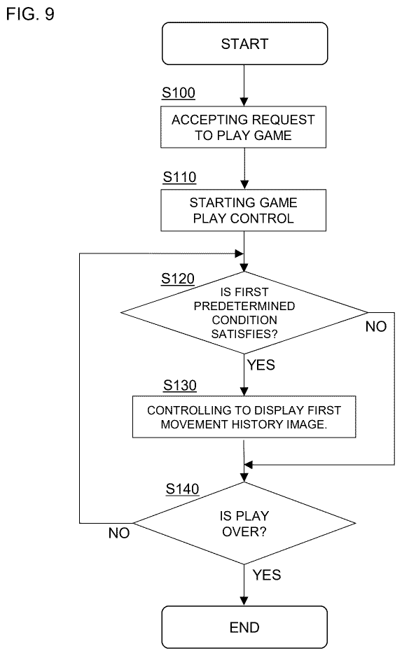

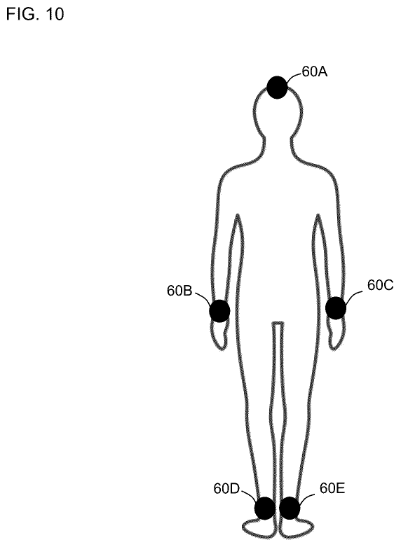

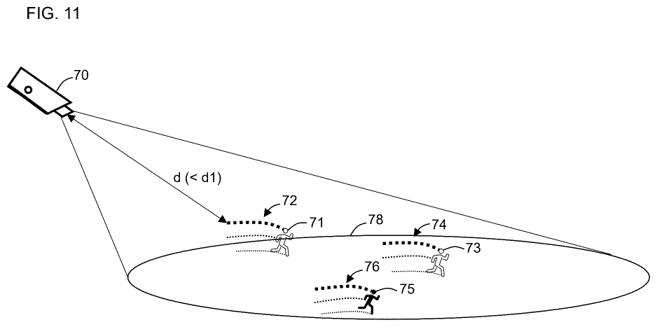

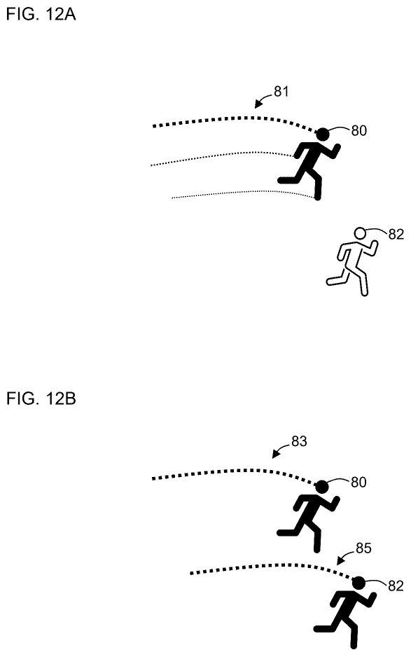

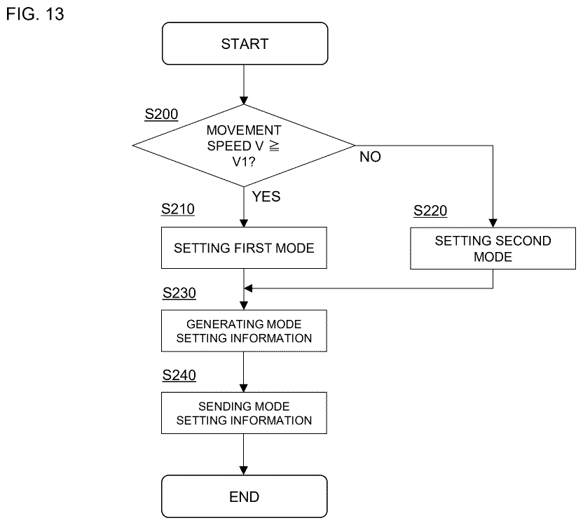

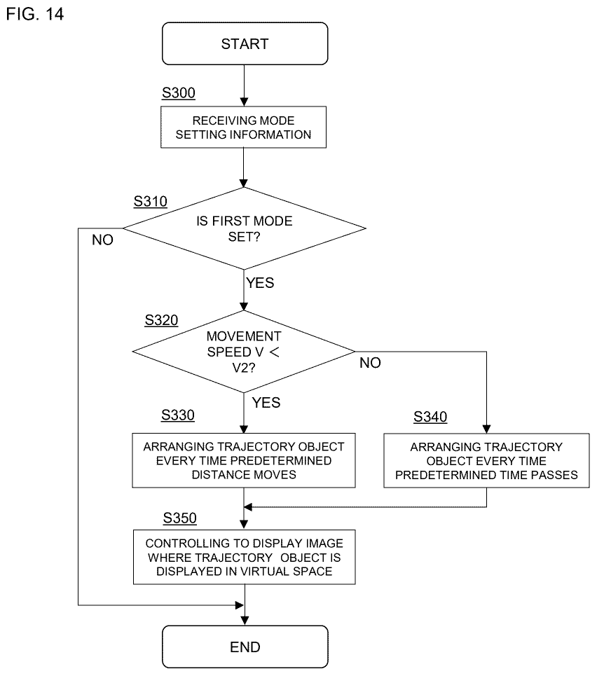

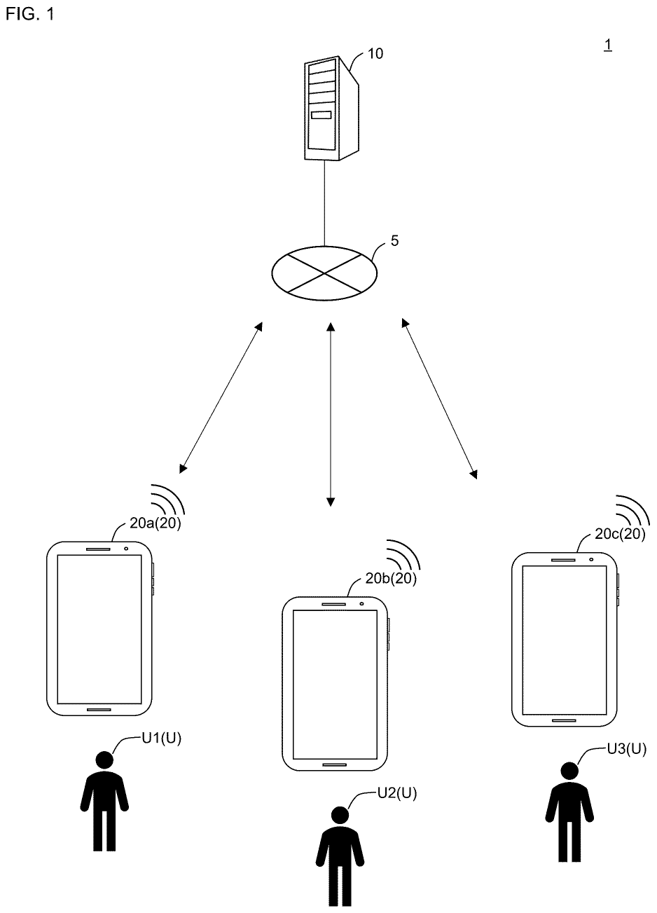

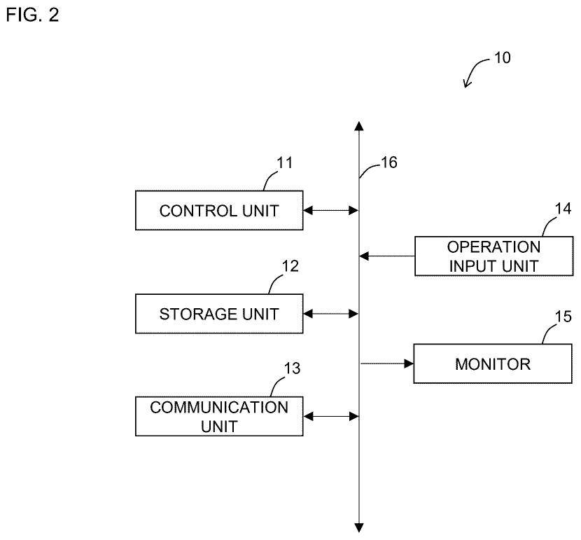

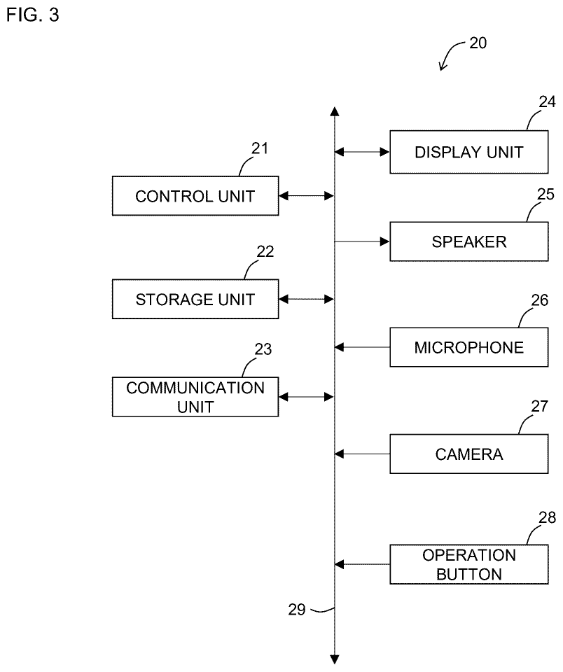

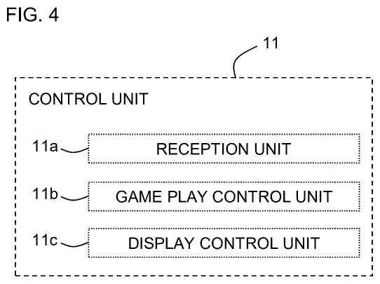

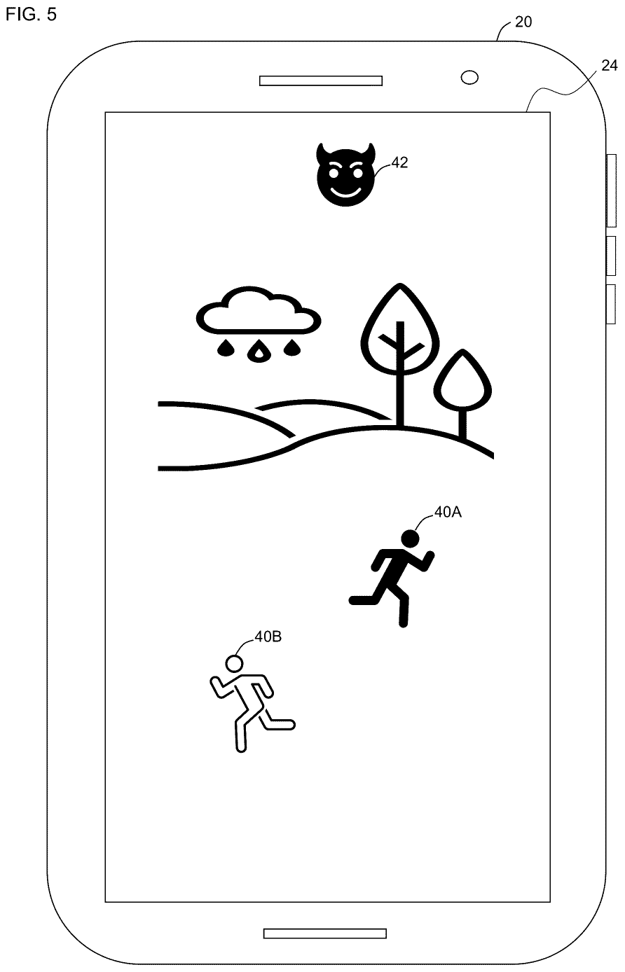

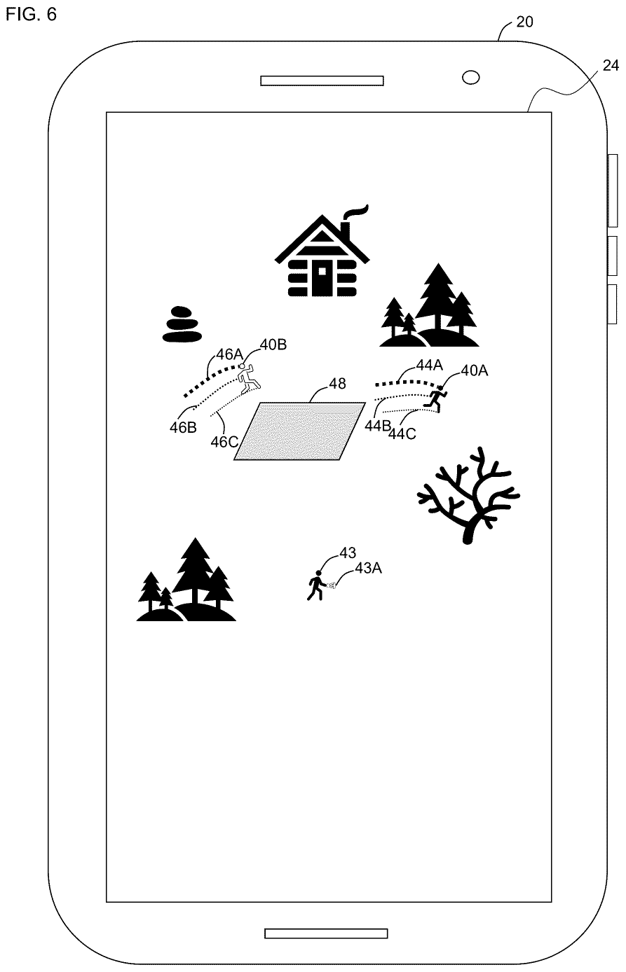

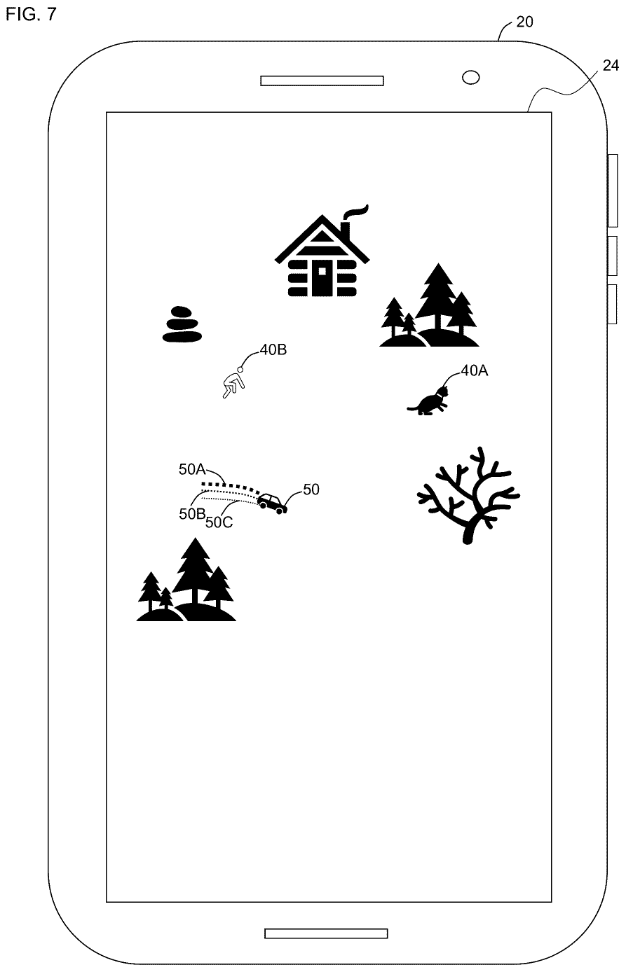

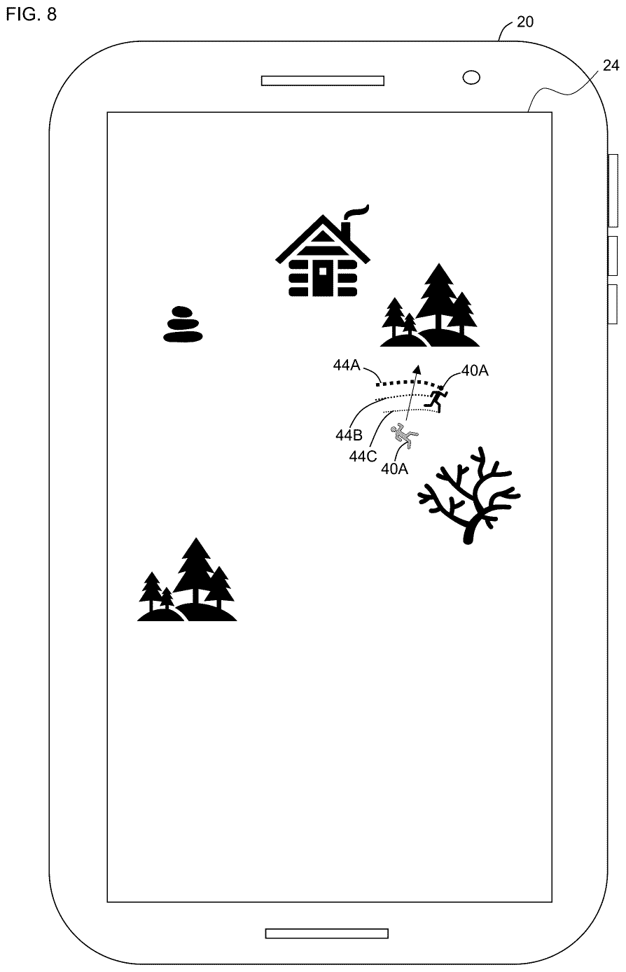

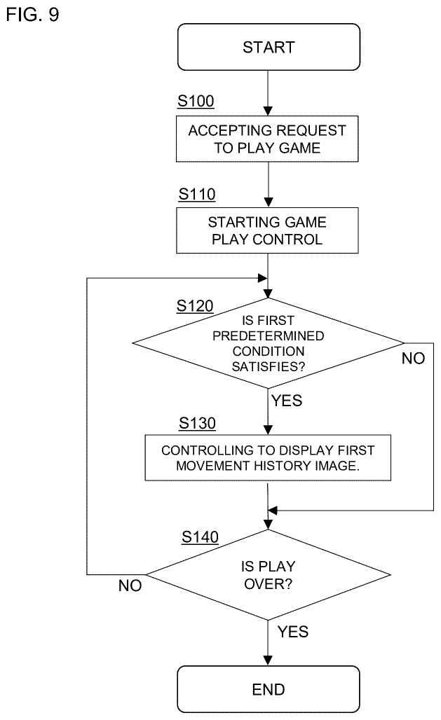

FIG. 9 is a flowchart showing an example of a display control processing (corresponding to the “information processing method” in this embodiment) performed by the server 10 in this embodiment.

First, the reception unit 11a accepts a request to play a game from the user U via the user U's operation on the display unit 24 of the user terminal 20 (step S100).

Next, when the request to play a game is accepted by the reception unit 11a, the game play control unit 11b controls the user U's play of the game (step S110).

Next, the display control unit 11c determines whether a first character corresponding to the infiltration side user U and arranged in the virtual space satisfies a first predetermined condition (specifically, the first character moves in the virtual space at a predetermined speed or faster) (step S120). When the result of the determination is that the first character does not satisfy the first predetermined condition (step S120, NO), the processing transitions to step S140.

On the other hand, when the first character satisfies the first predetermined condition (step S120, YES), the display control unit 11c controls to identifiably display a first movement history image (for example, a streamlined pink light image or an afterimage image of the first character) showing the movement history of the first character, for the defense side user U (step S130). It is noted that even when the second character (NPC) arranged in the virtual space satisfies the second predetermined condition (specifically, the second character moves in the virtual space at a predetermined speed or faster), the display control unit 11c does not control to identifiably display a second movement history image showing the movement history of the second character, for the defense side user U. Then, the process transitions to step S140.

In step S140, the game play control unit 11b determines whether the user U finished playing the game. When the result of the determination is that the user U did not finish playing the game (step S140, NO), processing returns to before step S120. On the other hand, when the user U finished playing the game (step S140, YES), the server 10 ends the processing shown in FIG. 9.

As described in detail above, in this embodiment, the server 10 (information processing device) includes the display control unit 11c. The display control unit 11c controls to identifiably display the first movement history image showing the movement history of the first character for the defense side user U when the first character corresponding to the infiltration side user U and arranged in the virtual space satisfies the first predetermined condition, and does not control to identifiably display the second movement history image showing the movement history of the second character for the defense side user U when the second character has attributes different from the infiltration side and is arranged in the virtual space satisfies the second predetermined condition.

According to this embodiment configured in this manner, the defense side user U can easily grasp the position of the first character that corresponds to the user U with a different attribute (infiltration side), satisfies the first predetermined condition, and is movable.

In the above embodiment, when the second character (NPC) satisfies the second predetermined condition, the display control unit 11c may control to identifiably display the second movement history image (for example, a streamlined light image or an afterimage image of the second character) showing the movement history of the second character, for the infiltration side user U. This allows the infiltration side user U to easily grasp the position of the second character, which has a different attribute (defense side), satisfies the second predetermined condition, and is movable.

In the above embodiment, the display control unit 11c may control to identifiably display the first movement history image in a first display aspect (for example, whether or not to display, shape, color, saturation, brightness, blinking, size, etc.) for the defense side user U when the first character of the infiltration side satisfies a first predetermined condition, and may control to identifiably display the second movement history image in a second display aspect (for example, whether or not to display, shape, color, saturation, brightness, blinking, size, etc.) different from the first display aspect for the infiltration side user U when the second character (NPC) of the defense side satisfies a second predetermined condition. In other words, the display aspect of the first movement history image for the defense side user U and the display aspect of the second movement history image for the infiltration side user U may be suitably different.

Furthermore, in the above embodiment, the display control unit 11c may vary the display aspect (for example, whether or not to display, shape, color, saturation, brightness level, blinking, size, etc.) of the first movement history image according to the display magnification of the virtual space displayed for the defense side user U. For example, the display control unit 11c may increase the brightness level of the first movement history image to a predetermined level or more as the display magnification of the virtual space displayed for the defense side user U increases, and may decrease the brightness level of the first movement history image to less than the predetermined level as the display magnification of the virtual space decreases.

In the above embodiment, the display control unit 11c may vary the display aspect of the first movement history image (for example, whether or not to display, shape, color, saturation, brightness level, blinking, size, etc.) according to the display aspect of the virtual space (for example, brightness). For example, when the brightness of the virtual space is set to “dark” and the first movement history image is easily noticeable to the defense side user U (the alert levels 1 and 2), the display control unit 11c may decrease the brightness level of the first movement history image to less than a predetermined level, and when the brightness of the virtual space is set to “bright” and the first movement history image is not easily noticeable to the defense side user U (the alert levels 4 and 5), the display control unit 11c may increase the brightness level of the first movement history image to more than a predetermined level.

Furthermore, in the above embodiment, the display control unit 11c may vary the display aspect (for example, whether or not to display, shape, color, saturation, brightness level, blinking, size, etc.) of the first movement history image according to the amount of time that passed since the start of game play. For example, when the amount of time that passed since the start of game play is short (the early part of the game), the display control unit 11c decreases the brightness level of the first movement history image to less than a predetermined level, and when the amount of time that passed since the start of game play is long (the late part of the game, when the time limit for the infiltration side user U to escape is about to expire), the display control unit 11c increases the brightness level of the first movement history image to more than a predetermined level.

Furthermore, in the above embodiment, the display control unit 11c may vary the display aspect (for example, whether or not to display, shape, color, saturation, brightness level, blinking, size, etc.) of the first movement history image according to the alert level of the game. For example, the display control unit 11c increases the brightness level of the first movement history image to a predetermined level or higher as the alert level of the game increases. In particular, the display control unit 11c may maximize the brightness level of the first movement history image when the alert level of the game reaches alert level 5 as a result of the infiltration side user U stealing the predetermined item.

### Second Embodiment

Next, a second embodiment of the present invention will be described. The following explanation focuses on the differences from the first embodiment. It is noted that configurations and effects that are not described are the same as those of the first embodiment.

### Configuration of Game System 1

As shown in FIG. 1, a game system 1 in this embodiment includes a server 10 and user terminals 20a, 20b, and 20c that communicate with the server 10. The user terminals 20a and 20b function as the “first user terminal” in this embodiment and are information processing terminals used by the infiltration side users U1 and U2 in the game provided by the game system 1. The user terminal 20c functions as the “second user terminal” in this embodiment and is an information processing terminal used by the defense side user U3 in the game provided by the game system 1. It is noted that the game system 1 functions as the “information processing system” in this embodiment.

### Hardware Configuration of Server 10

As shown in FIG. 2, the server 10 is configured with a control unit 11, a storage unit 12, a communication unit 13, an operation input unit 14, and a monitor 15. The control unit 11 functions as the “first processor” in this embodiment, and is hereinafter referred to as the “first processor”.

The first processor controls the movement of a infiltration side character that corresponds to the infiltration side users U1, U2 and is arranged in the virtual space (game space) based on operation information received from the user terminals 20a, 20b used by the infiltration side users U1, U2 (information generated by operation of the users U1, U2 at the user terminals 20a, 20b). The infiltration side character functions as the “first object” in this embodiment.

The first processor sets the infiltration side character to a first mode (for example, trajectory display mode: running) or a second mode (for example, trajectory non-display mode: walking) according to whether the infiltration side character satisfies a predetermined condition (for example, a running state). Whether the infiltration side character is running may be determined based on an operation received at the user terminal 20, or may be determined based on the movement speed of the infiltration side character.

In this embodiment, the first processor sets the infiltration side character to a first mode when the movement speed V of the infiltration side character is greater than or equal to a first threshold (for example, V1), and sets the infiltration side character to a second mode when the movement speed V of the infiltration side character is less than the first threshold (for example, V1). Thus, it is possible to set the infiltration side character to a suitable mode according to whether the movement speed V of the infiltration side character is greater than or equal to the first threshold.

### Hardware Configuration of User Terminal 20

As shown in FIG. 3, the user terminal 20 (the user terminal 20a, the user terminal 20b, the user terminal 20c) is configured with a control unit 21, a storage unit 22, a communication unit 23, a display unit 24, a speaker 25, a microphone 26, a camera 27, and operation buttons 28. The control unit 21 provided in the user terminal 20c used by the defense side user U3 functions as the “second processor” of this embodiment, and is hereinafter referred to as the second processor.

When the first mode (for example, trajectory display mode) is set for the infiltration side character, the second processor performs a display processing to display, on the display unit 24 (functioning as the “display” in this embodiment) of the user terminal 20c, an image where trajectory objects (for example, particle images) for displaying the movement trajectories of predetermined parts (for example, head, wrist, ankle) of the infiltration side character are displayed in a streamlined manner in virtual space together with the infiltration side character. On the other hand, when the second mode (for example, trajectory non-display mode) is set for the infiltration side object, the second processor does not perform the above-mentioned display processing.

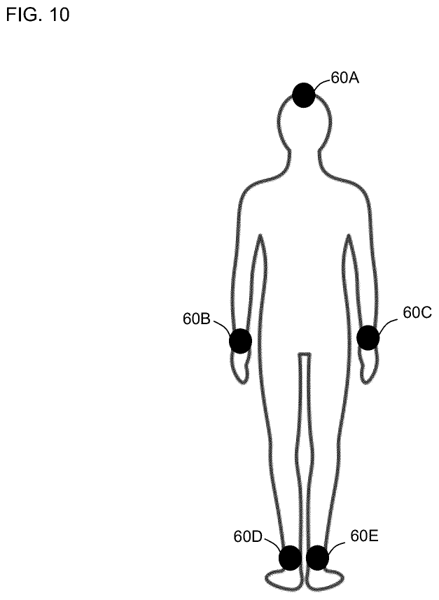

The storage unit 22 included in the user terminal 20c stores part information regarding predetermined parts where trajectory objects are arranged on the infiltration side character corresponding to the infiltration side users U1 and U2. The storage unit 22 also stores mode setting information (described later) received from the server FIG. 10 is an example of parts of an infiltration side character where trajectory objects are arranged. As shown in FIG. 10, trajectory objects are arranged on the head 60A, the right wrist 60B, the left wrist 60C, the right ankle 60D, and the left ankle 60E as predetermined parts of the infiltration side character. It is noted that trajectory objects may be arranged on parts other than the head, the wrists, and the ankles as predetermined parts of the infiltration side character, and may not be arranged on at least one of the head, the wrists, and the ankles.

When the movement speed V of the infiltration side character is equal to or greater than a first threshold (for example, V1) and less than a second threshold (for example, V2), the second processor arranges the trajectory object at the position of a predetermined part of the infiltration side character every time the predetermined part of the infiltration side character moves a predetermined distance. On the other hand, when the movement speed of the infiltration side character is equal to or greater than the second threshold (V2), the second processor arranges the trajectory object at the position of the predetermined part of the first object every time a predetermined time passes. This makes it possible to suppress the trajectory object from being displayed more than necessary when the movement speed of the infiltration side character is equal to or greater than the second threshold, that is, when the time it takes for the predetermined part of the infiltration side character to move a predetermined distance is shorter than when the movement speed of the infiltration side character is less than the second threshold, and to reduce the processing load of the user terminal 20c related to the display of the trajectory object. For example, when the movement speed V is equal to or greater than V1 and less than V2, one trajectory object is generated every time the distance D advances, and when the movement speed V is equal to or greater than V2, one trajectory object is generated every time a predetermined time passes. In this case, the time T is set to D/V2 or a value greater than that. By doing this, the number of trajectory objects generated can be prevented from becoming extremely large even when the movement speed V increases, and the processing load can be reduced.

The second processor controls the time for displaying the trajectory object.

For example, the display of the trajectory object is turned off after a first time (for example, T1: 1.5 to 2 seconds) has elapsed since the display of the trajectory object was started. This prevents the trajectory object from being displayed more than necessary, and reduces the processing load of the user terminal 20c related to the display of the trajectory object.

The second processor controls the display unit 24 to display a game image captured of the virtual space based on a virtual camera arranged in the virtual space. Then, when the distance between the trajectory object and the virtual camera is within a first distance, the second processor erases the display of the trajectory object before a first amount of time (for example, T1) has elapsed since the display of the trajectory object was started. This is because, when the distance between the trajectory object and the virtual camera is within the first distance, i.e., a short distance, drawing the trajectory object may hide at least a part of the infiltration side character or other objects arranged in the virtual space, reducing visibility.

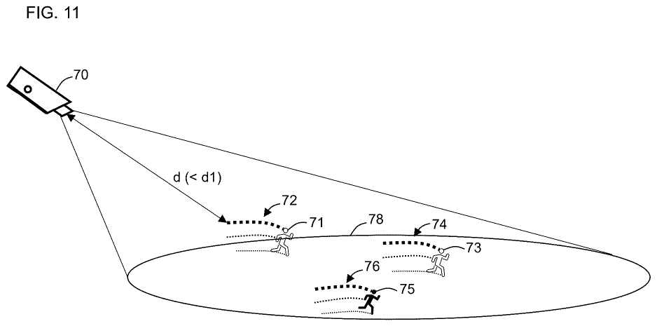

FIG. 11 is a diagram illustrating display control of the trajectory object according to the distance between the trajectory object and the virtual camera. As shown in FIG. 11, the second processor controls the display unit 24 to display the game image captured of the infiltration side characters 71, 73 and 75 in the virtual space based on the photographing range 78 of a virtual camera 70 arranged in the virtual space. The position of the virtual camera 70 moves within the virtual space according to the player's operation and the player character being followed.

In the example shown in FIG. 11, a first mode (for example, trajectory display mode) is set for the infiltration side characters of 71, 73, 75, and the second processor controls the display unit 24 to display an image where the infiltration side characters 71, 73, 75, together with trajectory objects 72, 74, 76 for displaying the movement trajectories of predetermined parts (for example, head, wrist, ankle) of the infiltration side characters 71, 73, 75 are displayed in a virtual space.

Here, when the distance d between the trajectory object 72 corresponding to the infiltration side character 71 and the virtual camera 70 is within the first distance (for example, d1), the second processor erases the display of the trajectory object 72 before the first amount of time (for example, T1) has elapsed since the display of the trajectory object 72 was started. It is noted that, because the distance d between the trajectory objects 74, 76 corresponding to the infiltration side characters 73, 75 and the virtual camera 70 is longer than the first distance (for example, d1), the second processor does not erase the display of the trajectory objects 74, 76 before the first amount of time (for example, T1) has elapsed since the display of the trajectory objects 74, 76 was started. This ensures that the display of the trajectory object 72 does not impede the user U3 using the user terminal 20c from grasping the game situation.

The second processor controls at least one of the color or brightness of the trajectory object based on at least one of the color or brightness of the background image around the infiltration side character in the virtual space. For example, when the brightness corresponding to at least one of the color or brightness of the background image around the infiltration side character is set to “dark” and the trajectory object is relatively noticeable to the defense side user U3 (for example, alert level 1, 2), the second processor reduces the brightness corresponding to at least one of the color or brightness of the trajectory object to less than a predetermined level. When the brightness corresponding to at least one of the color or brightness of the background image around the infiltration side character is set to “bright” and the trajectory object is relatively less noticeable to the defense side user U3 (for example, alert level 4, 5), the second processor increases the brightness corresponding to at least one of the color or brightness of the trajectory object to the predetermined level or more. This allows the color and brightness of the trajectory object to be appropriately controlled according to the color and brightness of the background image around the infiltration side character, improving the visibility of the trajectory object for the defense side user U3.

The second processor displays the trajectory object in a first aspect (for example, an aspect where the brightness level of the trajectory object is equal to or greater than a predetermined level) when the infiltration side character is in the first form, and displays the trajectory object in a second aspect (for example, an aspect where the brightness level of the trajectory object is less than a predetermined level) when the infiltration side character is in the second form. Here, the infiltration side character being in the first form means, for example, a form where the infiltration side character uses a first skin (for example, first clothing, first display color) or a form where the infiltration side character is a first character (for example, a human). The infiltration side character being in the second form means, for example, a form where the infiltration side character uses a second skin (for example, second clothing, second display color) or a form where the infiltration side character is a second character (for example, an animal). In this way, by appropriately changing the display form of the trajectory object (for example, whether or not to display, shape, color, saturation, brightness level, blinking, size, etc.) according to the form of the infiltration side character, the distinguishability of the form of the infiltration side character can be improved for the defense side user U3.

When a first mode (trajectory display mode) is set for a first infiltration side character (corresponding to the “first object” in this embodiment) and a second infiltration side character (corresponding to the “second object” in this embodiment) that is arranged near the first infiltration side character in the virtual space is also set for the first mode (trajectory display mode), the second processor controls to display a trajectory object for displaying a movement trajectory for a first number (for example, 1) of parts of the first infiltration side character. On the other hand, when the first mode is set for a first infiltration side character and a second mode (trajectory non-display mode) is set for the second infiltration side character that is arranged near the first infiltration side character in the virtual space without being set for the first mode, the second processor controls to display a trajectory object for displaying a movement trajectory for a second number (for example, 3) of parts of the first infiltration side character that is greater than the first number.

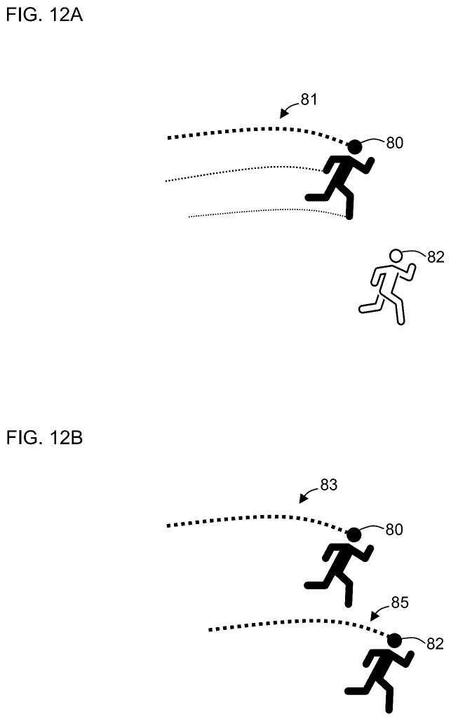

FIG. 12 is a diagram for explaining the control of the number of parts where trajectory objects are displayed in the first infiltration side character. As shown in FIG. 12A, when the first mode (trajectory display mode) is set for the first infiltration side character 80 and the second mode (trajectory non-display mode) is set for the second infiltration side character 82 arranged near the first infiltration side character 80 in the virtual space, that is, when no trajectory object corresponding to the second infiltration side character 82 is displayed, the second processor controls to display trajectory objects 81 for displaying movement trajectories for a second number of parts of the first infiltration side character 80 (three in the illustrated example: the head, wrists, and ankles). On the other hand, as shown in FIG. 12B, when the first mode (trajectory display mode) is set for the first infiltration side character 80 and the mode set for the second infiltration side character 82 arranged near the first infiltration side character 80 in the virtual space changes from the second mode (trajectory non-display mode) to the first mode (trajectory display mode), that is, when a new trajectory object corresponding to the second infiltration side character 82 is displayed, the second processor controls to display a trajectory object 83 for displaying a movement trajectory for the first number of parts of the first infiltration side character 80 (in the illustrated example, one of the head) and a trajectory object 85 for displaying a movement trajectory for the first number of parts of the second infiltration side character 82 (in the illustrated example, one of the head). In this way, when the first mode is set for the first infiltration side character 80 and the second infiltration side character 82 arranged near the first infiltration side character 80, the defense side user U3 can visually recognize the trajectory objects corresponding to the first infiltration side character 80 and the second infiltration side character 82 arranged near each other by suppressing the display of more trajectory objects than necessary corresponding to the first infiltration side character 80, thereby suppressing the total number of trajectory objects drawn, and reducing the processing load of the user terminal 20c related to the display of the trajectory objects. The number of trajectory objects is not limited to the above example. In addition, in the above example, the first character and the second character being arranged near each other may be a positional relationship where the first character and the second character are displayed on the same game screen by the same virtual camera, or may be a positional relationship where the first character and the second character are within a predetermined distance in the virtual space.

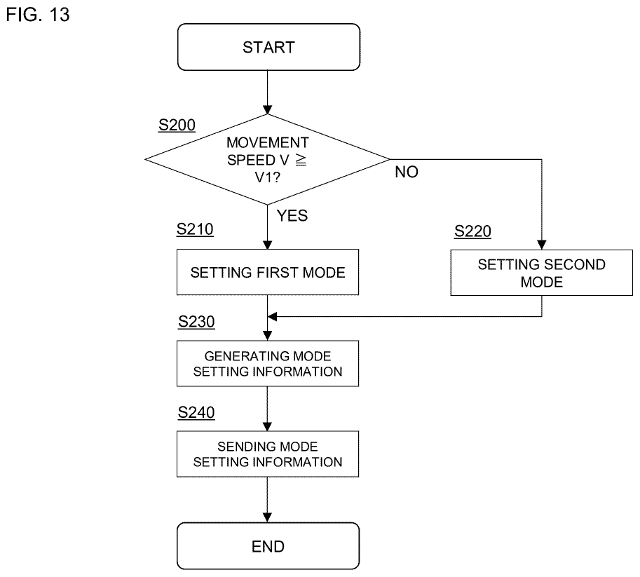

FIG. 13 is a flowchart showing an example of a mode setting processing performed by the server 10 in this embodiment.

First, the first processor determines whether or not the movement speed V of the infiltration side character is equal to or greater than a first threshold value (for example, V1) (step S200).

When it is determined that the movement speed V of the infiltration side character is equal to or greater than the first threshold value (for example, V1) (step S200, YES), the first processor sets the infiltration side character to a first mode (for example, a trajectory display mode) (step S210). Then, the processing transitions to step S230.

On the other hand, when the movement speed V of the character of the infiltration side is less than the first threshold value (for example, V1) (step S200, NO), the first processor sets the infiltration side character to the second mode (for example, the trajectory non-display mode) (step S220). Then, the processing transitions to step S230.

In step S230, the first processor generates mode setting information including the mode (first mode or second mode) set for the infiltration side character in step S210 or step S220 and, when the first mode is set, the movement speed V of the infiltration side character. Finally, the first processor controls the communication unit 13 to transmit the mode setting information generated in step S230 from the server 10 to the user terminal 20c used by the defense side user U3 (step S240). When the processing of step S240 is completed, the server 10 ends the processing shown in FIG. 13.

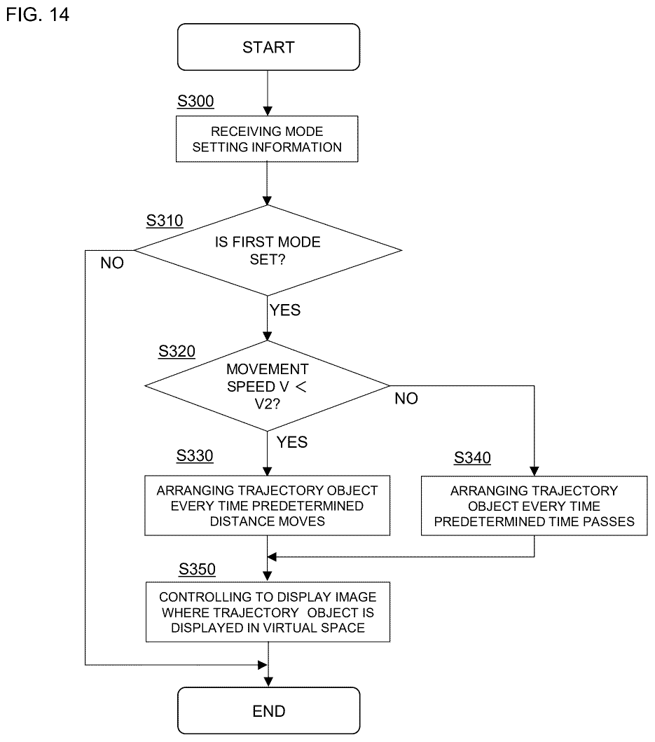

FIG. 14 is a flowchart showing an example of a display control processing performed by a user terminal 20c used by the defense side user U3 in this embodiment.

First, the second processor receives the mode setting information transmitted from the server 10 to the user terminal 20c via the communication unit 23 (step S300). Then, the second processor stores the received mode setting information in the storage unit 22.

Next, the second processor refers to the mode setting information and determines whether the first mode (trajectory display mode) is set for the infiltration side character (step S310). When the result of the determination is that the first mode is not set for the infiltration side character, that is, the second mode (trajectory non-display mode) is set (step S310, NO), the user terminal 20c ends the processing shown in FIG. 14.

On the other hand, when the first mode is set for the infiltration side character (step S310, YES), the second processor refers to the mode setting information and determines whether the movement speed V of the infiltration side character is less than a second threshold value (for example, V2) (step S320). When the result of the determination is that the movement speed V of the infiltration side character is less than the second threshold value (step S320, YES), the second processor arranges a trajectory object at the position of a predetermined part of the infiltration side character each time the predetermined part of the infiltration side character moves a predetermined distance (step S330). Then, the processing transitions to step S350.

On the other hand, when the movement speed V of the infiltration side character is equal to or greater than the second threshold value (step S320, NO), the second processor arranges a trajectory object at a predetermined part of the infiltration side character every time a predetermined amount of time passes (step S340). Then, the processing transitions to step S350.

Finally, in step S350, the second processor performs a display processing to display, on the display unit 24 included in the user terminal 20c, an image where trajectory objects (for example, particle images) for displaying the movement trajectories of predetermined parts (for example, head, wrist, ankle) of the infiltration side character are displayed in a streamlined manner in virtual space together with the infiltration side character. When the processing of step S350 is completed, the user terminal 20c ends the processing shown in FIG. 14.

As described above in detail, in this embodiment, the game system 1 (information processing system) includes the server 10, and the user terminals 20a and 20b (first user terminals) and the user terminal 20c (second user terminal) that communicate with the server 10. The server 10 includes the first processor (the control unit 11). The first processor controls the movement of an infiltration side character (the first object) arranged in the virtual space based on operation information received from the user terminals 20a and 20b (used by the infiltration side users U1 and U2), and sets the infiltration side character to the first mode (trajectory display mode) or the second mode (trajectory non-display mode) according to whether the infiltration side character satisfies the predetermined condition (running state).

The user terminal 20c (used by the defense side user U3) includes the second processor (the control unit 21). When the first mode is set for the infiltration side character, the second processor performs a display processing for displaying on the display unit 24 (display) an image where the infiltration side character and trajectory objects for displaying the movement trajectory of predetermined parts (head, wrist, ankle) of the infiltration side character are displayed in a virtual space, and when the second mode is set for the infiltration side character, the second processor does not performs the above display processing.

According to this embodiment configured in this manner, the movement control of the infiltration side character and the mode setting for the infiltration side character are performed on the server 10 side, and the display of the trajectory object is performed on the user terminal 20c side, thereby distributing the processing load and reducing the processing load on the server 10, and ultimately improving the functionality of the computer system (the game system 1).

It is noted that the above first and second embodiments are merely examples of specific embodiments for carrying out one embodiment of the present invention, and the technical scope of the present invention should not be interpreted in a limited manner based on these. In other words, the present invention can be implemented in various forms without departing from the gist or main features of the present invention.

### SUMMARY

### General Technical Problem

One of the purposes of this embodiment is to make it possible to easily grasp the position of an object.

### Technical Problem Corresponding to [Additional Note 1]

One of the purposes of this embodiment is to make it possible to easily grasp the location of a game medium that corresponds to a user with a different attribute and satisfies a predetermined condition, and that is movable.

### Additional Note 1

The information processing device according to this embodiment comprises a display control unit that, when a first game medium that corresponds to a user with a first attribute and is arranged in a virtual space satisfies a predetermined condition, controls to display a first movement history image showing the movement history of the first game medium for a user with a second attribute, and, when a second game medium that has an attribute different from the first attribute and is arranged in the virtual space satisfies the predetermined condition, does not control to display a second movement history image showing the movement history of the second game medium for a user with the second attribute.

According to the above information processing device, it is possible to easily grasp the location of the first game medium that corresponds to a user with a different attribute (the first attribute: infiltration side), that satisfies the predetermined condition, and that is movable.

### Technical Problem Corresponding to [Additional Note 2]

One of the purposes of this embodiment is to enable a user with a first attribute to easily grasp the location of a second game medium that has a different attribute, satisfies a specified condition, and is movable.

### Additional Note 2

The information processing device of additional note 1, wherein the display control unit controls to display the second movement history image for a user with the first attribute when the second game medium satisfies the predetermined condition. Thereby, it is possible for a user with the first attribute to easily grasp the location of the second game medium that has a different attribute, satisfies the predetermined condition, and is movable.

### Technical Problem Corresponding to [Additional Note 3]

One of the purposes of this embodiment is to enable a user with a first attribute to at least grasp the location of a first game medium with the same attribute.

### Additional Note 3

The information processing device of additional note 1 or 2, wherein the display control unit does not control to display the first movement history image to a user with the first attribute when the first game medium satisfies a predetermined condition.

Therefore, it is possible to enable a user with a first attribute to at least grasp the location of a first game medium with the same attribute.

### Technical Problem Corresponding to [Additional Note 4]

One of the purposes of this embodiment is to suitably differentiate between the display aspect of the first movement history image for a user with a second attribute and the display aspect of the second movement history image for a user with a first attribute.

### Additional Note 4

The information processing device of any one of additional notes 1 to 3, wherein the display control unit controls to display a first movement history image in a first display aspect to a user with a second attribute when the first game medium satisfies a predetermined condition, and controls to display a second movement history image in a second display aspect different from the first display aspect for a user with the first attribute when the second game medium satisfies the predetermined condition. Thereby, it is possible to suitably differentiate between the display aspect of the first movement history image for a user with a second attribute and the display aspect of the second movement history image for a user with a first attribute.

### Technical Problem Corresponding to [Additional Note 5]

One of the purposes of present embodiment is to enable a user with a second attribute to easily grasp the location of a specific part of the first game medium.

### Additional Note 5

The information processing device of any one of additional notes 1 to 4, wherein the display control unit controls to display a part movement history image showing a movement history of the part of the first game medium in a display aspect that differs for each part of the first game medium for a user with the second attribute when the first game medium satisfies a predetermined condition.

Thereby, it is possible for a user with the second attribute to easily grasp the position of the specific part of the first game medium by referring to the part movement history image where the display aspect differs for each part of the first game medium.

### Technical Problem Corresponding to [Additional Note 6]

One of the purposes of this embodiment is to enable a user with a second attribute to easily grasp the location of a specific part of the first game medium.

### Additional Note 6

The information processing device of additional note 5, wherein the display control unit varies the display aspect of the part movement history image according to the positional relationship between a predetermined position and the position of the part of the first game medium in the virtual space.

Thereby, it is possible for a user with the second attribute to easily grasp the position of the specific body part of the first game medium by referring to the part movement history image where the display aspect differs according to the positional relationship between the predetermined position and the position of the part of the first game medium in the virtual space.

### Technical Problem Corresponding to [Additional Note 7]

One of the purposes of this embodiment is to vary the display aspect of the first movement history image according to whether the first game medium is in a predetermined state.

### Additional Note 7

The information processing device of any one of additional notes 1 to 6, wherein the display control unit varies the display aspect of the first movement history image according to whether the first game medium is in a predetermined state.

Thereby, it is possible to suitably vary the display aspect of the first movement history image according to whether the first game medium is in a predetermined state.

### Technical Problem Corresponding to [Additional Note 8]

One of the purposes of this embodiment is to enable a user with a second attribute to easily grasp that a third game medium is moving in association with a first game medium.

### Additional Note 8

The information processing device of any one of additional notes 1 to 7, wherein the display control unit controls to display a third movement history image showing the movement history of the third game medium in the same display aspect as the first movement history image for a user with the second attribute when the third game medium is moving in association with the first game medium.

Thereby, it is possible for a user with the second attribute to easily grasp that the third game medium is moving in association with the first game medium.

### Technical Problem Corresponding to [Additional Note 9]

One of the purposes of this embodiment is to make it difficult for a user with the second attributes to grasp the location of the first game medium.

The information processing device of any one of additional notes 1 to 8, wherein the display control unit controls to display a first movement history image related to a predetermined movement direction of the first game medium, and then, while the first movement history image is displayed, when the first game medium passes through a position where the first movement history image is displayed again in a direction different from the predetermined movement direction, erases the display of the first movement history image.

Thereby, it is possible to make it difficult for a user with the second attributes to grasp the location of the first game medium.

### Technical Problem Corresponding to [Additional Note 10]

One of the purposes of this embodiment is to vary the display aspect of the first movement history image according to the display magnification of the virtual space.

### Additional Note 10

The information processing device of any one of additional notes 1 to 9, wherein the display control unit controls to vary the display aspect of the first movement history image according to the display magnification of the virtual space.

Thereby, it is possible to suitably vary the display aspect of the first movement history image according to the display magnification of the virtual space.

### Technical Problem Corresponding to [Additional Note 11]

One of the purposes of this embodiment is to vary the display aspect of the first movement history image according to the display aspect of the virtual space.

### Additional Note 11

The information processing device of any one of additional notes 1 to 10, wherein the display control unit controls to vary the display aspect of the first movement history image according to the display aspect of the virtual space.

Thereby, it is possible to suitably vary the display aspect of the first movement history image according to the display aspect of the virtual space.

### Technical Problem Corresponding to [Additional Note 12]

One of the purposes of this embodiment is to make it possible to easily grasp the location of a game medium that corresponds to a user with a different attribute and satisfies a predetermined condition, and that is movable.

### Additional Note 12

In the information processing method of this embodiment, a processor controls to display a first movement history image showing the movement history of a first game medium for a user with a second attribute when the first game medium that corresponds to a user with a first attribute and is arranged in a virtual space satisfies a predetermined condition, and does not control to display a second movement history image showing the movement history of a second game medium for a user with the second attribute when the second game medium that has an attribute different from the first attribute and is arranged in the virtual space satisfies the predetermined condition.

According to the above information processing method, it is possible to easily grasp the location of the first game medium that corresponds to a user with a different attribute, that satisfies the predetermined condition, and that is movable.

### Technical Problem Corresponding to [Additional Note 13]

One of the purposes of this embodiment is to make it possible to easily grasp the location of a game medium that corresponds to a user with a different attribute and satisfies a predetermined condition, and that is movable.

The information processing program of this embodiment causes a processor to perform processing to control to display a first movement history image showing the movement history of a first game medium for a user with a second attribute when the first game medium that corresponds to a user with a first attribute and is arranged in a virtual space satisfies a predetermined condition, and not to control to display a second movement history image showing the movement history of a second game medium for a user with the second attribute when the second game medium that has an attribute different from the first attribute and is arranged in the virtual space satisfies the predetermined condition.

According to the above information processing program, it is possible to easily grasp the location of the first game medium that corresponds to a user with a different attribute, that satisfies the predetermined condition, and that is movable.

### Technical Problem Corresponding to [Additional Note 14]

One of the purposes of this embodiment is to reduce the processing load of a server.

### Additional Note 14

The information processing system comprises a server, a first user terminal and a second user terminal that communicate with the server. The server includes a first processor that controls a movement of a first object arranged in a virtual space based on operation information received from the first user terminal, and that sets the first object for a first mode or a second mode according to whether the first object satisfies a predetermined condition. The second user terminal includes a second processor that performs a display processing to display on a display an image where a trajectory object for displaying a movement trajectory of a predetermined part of the first object is displayed in the virtual space together with the first object when the first mode is set for the first object, and that does not perform the display processing when the second mode is set for the first object.

According to the above information processing system, by controlling the movement of the object and setting the mode for the object on the server side, and displaying the trajectory object on the user terminal side, the processing load is distributed and the processing load on the server can be reduced.

### Technical Problem Corresponding to [Additional Note 15]

One of the purposes of this embodiment is to make it possible to set a suitable mode for a first object according to the movement speed of the first object.

### Additional Note 15

The information processing system of additional note 14, wherein the first processor sets the first mode for the first object when a movement speed of the first object is equal to or greater than a first threshold, and sets the second mode for the first object when the movement speed of the first object is less than the first threshold. Thereby, it is possible to set a suitable mode for a first object according to whether the movement speed of the first object is equal to or greater than the first threshold.

### Technical Problem Corresponding to [Additional Note 16]

One of the purposes of this embodiment is to reduce the processing load of the user terminal related to the display of the trajectory object.

### Additional Note 16

The information processing system of additional note 15, wherein the second processor arranges a trajectory object at a position of a predetermined part of the first object each time the predetermined part of the first object moves a predetermined distance when the movement speed of the first object is greater than or equal to the first threshold and less than a second threshold, and the second processor arranges a trajectory object at a position of a predetermined part of the first object every time a predetermined amount of time passes when the movement speed of the first object is equal to or greater than the second threshold value.

Thereby, when the movement speed of the first object is equal to or greater than the second threshold, the display of more trajectory objects than necessary can be suppressed, thereby reducing the processing load of the user terminal related to the display of the trajectory objects.

### Technical Problem Corresponding to [Additional Note 17]

One of the purposes of this embodiment is to reduce the processing load of the user terminal related to the display of the trajectory object.

### Additional Note 17

The information processing system of any one of additional notes 14 to 16, wherein the second processor controls an amount of time for displaying the trajectory object, and the second processor erases a display of the trajectory object after a first amount of time passed since the display of the trajectory object started.

Thereby, it is possible to reduce the processing load of the user terminal related to the display of the trajectory object.

### Technical Problem Corresponding to [Additional Note 18]

One of the purposes of this embodiment is to improve the visibility of the trajectory object.

### Additional Note 18

The information processing system of additional note 17, wherein the second processor controls to display a game image taken from the virtual space on the display based on a virtual camera arranged in the virtual space, and the second processor erases the display of the trajectory object before the first amount of time passes since the display of the trajectory object started when a distance between the trajectory object and the virtual camera is within a first distance.

Thereby, by suitably changing the display amount of time of the trajectory object according to whether the distance between the trajectory object and the virtual camera is within the first distance, the visibility of the trajectory object where the distance from the virtual camera is longer than the first distance can be improved.

### Technical Problem Corresponding to [Additional Note 19]

One of the purposes of this embodiment is to improve the visibility of the trajectory object.

### Additional Note 19

The information processing system of any one of additional notes 14 to 18, wherein the second processor controls at least one of the color or brightness of the trajectory object based on at least one of the color or brightness of a background image around the first object in the virtual space.

Thereby, by suitably controlling the color and brightness of the trajectory object according to the color and brightness of the background image around the first object, the visibility of the trajectory object can be improved.

### Technical Problem Corresponding to [Additional Note 20]

One of the purposes of this embodiment is to improve the distinguishability of a form of the first object.

### Additional Note 20

The information processing system of any one of additional notes 14 to 19, wherein the second processor displays the trajectory object in a first form when the first object is in a first form, and displays the trajectory object in a second form when the first object is in a second form.

Thereby, by suitably changing the display aspect of the trajectory object according to the form of the first object, it is possible to improve the distinguishability of the form of the first object.

### Technical Problem Corresponding to [Additional Note 21]

One of the purposes of this embodiment is to reduce the processing load of the user terminal related to the display of the trajectory object.

### Additional Note 21

The information processing system of any one of additional notes 14 to 20, wherein the second processor displays a trajectory object for displaying a movement trajectory for a first number of parts of the first object when the first mode is set for the first object and the first mode is set for a second object arranged near the first object in the virtual space, the second processor displays a trajectory object for displaying a movement trajectory for a second number of parts of the first object when the first mode is set for the first object and the first mode is not set for a second object arranged near the first object in the virtual space, and the first number is smaller than the second number.

Thereby, when the first mode is set for the second object that is arranged near the first object, the display of more trajectory objects than necessary can be suppressed, thereby reducing the processing load of the user terminal related to the display of the trajectory object.

### Technical Problem Corresponding to [Additional Note 22]

One of the purposes of this embodiment is to reduce the processing load of a server.

### Additional Note 22

In the information processing method, a processor of a server controls a movement of a first object arranged in a virtual space based on operation information received from a user terminal, and sets a first mode or a second mode for the first object according to whether the first object satisfies a predetermined condition, a processor of a user terminal performs a display processing to display on a display an image where a trajectory object for displaying a movement trajectory of a predetermined part of the first object is displayed in the virtual space together with the first object when the first mode is set for the first object, and does not perform the display processing when the second mode is set for the first object.

According to the above information processing method, by controlling the movement of the object and setting the mode for the object on the server side, and displaying the trajectory object on the user terminal side, the processing load is distributed and the processing load on the server can be reduced.

### REFERENCE SIGNS LIST

1: game system, 10: server, 11: control unit, 11a: reception unit, 11b: game play control unit, 11c: display control unit, 12: storage unit, 13: communication unit, 14: operation input unit, 15: monitor, 16: system bus, 20, 20a, 20b, 20c: user terminal, 21: control unit, 22: storage unit, 23: communication unit, 24: display unit, 25: speaker, 26: microphone, 27: camera, 28: operation button, 29: system bus, 40A, 40B: first character, 42, 43: second character, 43a: means of searching for enemies, 44A, 44B, 44C, 46A, 46B, 46C, 50A, 50B, 50C: part movement history image, 48: irradiation area, 50: specific object, 60A: head, 60B: right wrist, 60C: left wrist, 60D: right ankle, 60E: left ankle, 70: virtual camera, 71, 73, 75: infiltration side character, 72, 74, 76, 81, 83, 85: trajectory object, 80: first infiltration side character, 82: second infiltration side character, U, U1, U2, U3: user

1. An information processing system comprising a server, a first user terminal and a second user terminal that communicate with the server, wherein
the server includes a first processor,
the first processor controls a movement of a first object arranged in a virtual space based on operation information received from the first user terminal,
the first processor sets the first object for a first mode or a second mode according to whether the first object satisfies a predetermined condition,
the second user terminal includes a second processor,
the second processor performs a display processing to display on a display an image where a trajectory object for displaying a movement trajectory of a predetermined part of the first object is displayed in the virtual space together with the first object when the first mode is set for the first object, and
the second processor does not perform the display processing when the second mode is set for the first object.

2. The information processing system of claim 1, wherein
the first processor sets the first mode for the first object when a movement speed of the first object is equal to or greater than a first threshold, and sets the second mode for the first object when the movement speed of the first object is less than the first threshold.

3. The information processing system of claim 2, wherein
the second processor arranges a trajectory object at a position of a predetermined part of the first object each time a predetermined part of the first object moves a predetermined distance when a movement speed of the first object is greater than or equal to the first threshold and less than a second threshold, and
the second processor arranges a trajectory object at a position of a predetermined part of the first object every time a predetermined amount of time passes when a movement speed of the first object is equal to or greater than the second threshold value.

4. The information processing system of claim 1, wherein
the second processor controls an amount of time for displaying the trajectory object, and
the second processor erases a display of the trajectory object after a first amount of time passed since a display of the trajectory object started.

5. The information processing system of claim 4, wherein
the second processor controls to display a game image taken from the virtual space on the display based on a virtual camera arranged in the virtual space, and
the second processor erases a display of the trajectory object before the first amount of time passes since the display of the trajectory object started when a distance between the trajectory object and the virtual camera is within a first distance.

6. The information processing system of claim 1, wherein
the second processor controls at least one of a color or brightness of the trajectory object based on at least one of a color or brightness of a background image around the first object in the virtual space.

7. The information processing system of claim 1, wherein
the second processor displays the trajectory object in a first aspect when the first object is in a first form, and displays the trajectory object in a second aspect when the first object is in a second form.

8. The information processing system of claim 1, wherein
the second processor displays a trajectory object for displaying a movement trajectory for a first number of parts of the first object when the first mode is set for the first object and the first mode is set for a second object arranged near the first object in the virtual space,
the second processor displays a trajectory object for displaying a movement trajectory for a second number of parts of the first object when the first mode is set for the first object and the first mode is not set for a second object arranged near the first object in the virtual space, and
the first number is smaller than the second number.

9. An information processing method, wherein
a processor of a server controls a movement of a first object arranged in a virtual space based on operation information received from a user terminal, and sets a first mode or a second mode for the first object according to whether the first object satisfies a predetermined condition,
a processor of a user terminal performs a display processing to display on a display an image where a trajectory object for displaying a movement trajectory of a predetermined part of the first object is displayed in the virtual space together with the first object when the first mode is set for the first object, and does not perform the display processing when the second mode is set for the first object.
